(19) United States
(12) Patent Application Publication
(10) Pub. No.: US 2012/0329420 A1
(43) Pub. Date: Dec. 27, 2012

(54) PERSONAL SAFETY APPLICATION FOR MOBILE DEVICE AND METHOD

(75) Inventors: Bradly Michael Zotti, Denver, CO (US); David D. Dixon, Denver, CO (US); Charles Richardson Groves, Denver, CO (US)

(73) Assignee: SOTERIA SYSTEMS, LLC, Denver, CO (US)

(21) Appl. No.: 13/508,953

(22) PCT Filed: Nov. 11, 2010
(86) PCT No.: PCT/US10/56346

§ 371 Date: Sep. 4, 2012

Related U.S. Application Data
(60) Provisional application No. 61/260,672, filed on Nov. 12, 2009.

(51) Int. Cl. H04W 4/22

(52) U.S. Cl. 455/404.2

(57) ABSTRACT

A method of notifying an intermediary located remote from a user of an emergency service requested by the user associated with a mobile communication device includes receiving, at the intermediary, an alarm signal generated by a user interaction with a safety application on the mobile communication device. Upon receipt, an audio communication link or a video communication link is activated between the mobile communication device and the intermediary based on the user's interaction with the safety application. Information, such as static personal user information and dynamic location information of the mobile communication device, is presented to the intermediary. The intermediary may then contact a third party based on a communication between the user and the intermediary and a location of the mobile communication device.

This application is being filed on 11 Nov. 2010, as a PCT International Patent application in the name of Soteria Systems, LLC, a U.S. national corporation, applicant for the designation of all countries except the US, and Brad Zotti, Dave Dixon, and Charlie Groves, all citizens of the U.S., applicants for the designation of the US only, and claims priority to U.S. Provisional patent application Ser. No. 61/260,672, filed Nov. 12, 2009.

### INTRODUCTION

In the United States and other countries, emergency services (e.g., police, fire, medical) are easily accessible via a special phone number (e.g., 911). Calling this number automatically connects the caller with emergency services call center personnel that may provide the necessary emergency services. This system, while effective, has certain limitations, however. For example, the information available to the call center personnel may be a phone number from which the call is coming and an address that may be linked to that phone number. With the increased use of mobile phones, however, it is less easy to identify location of the caller based on the mobile phone number. Additionally, when call center personnel answer a distress call, they have no information about the caller or the activities at the scene of the incident.

So often during a crisis or distress situation a person does not have enough time to call 911, wait to be connected with a call center personnel, and then provide all the necessary information for the appropriate authorities to respond. If that notification process is averted or interrupted, the opportunity to prevent or minimize the crisis is likely lost. Additionally, the crisis may take the victim away from the original location making it difficult, if not impossible, to locate the person if and when authorities are dispatched.

### SUMMARY OF THE INVENTION

In one aspect, the invention relates to a method of notifying an intermediary located remote from a user of an emergency service requested by the user associated with a mobile communication device, the method including: receiving, at the intermediary, an alarm signal generated by a user interaction with a safety application on the mobile communication device; activating at least one of an audio communication link and a video communication link between the mobile communication device and the intermediary based on the user's interaction with the safety application; presenting to the intermediary a static personal information regarding the user; presenting to the intermediary a dynamic location information of the mobile communication device; and contacting a third party based on at least one of (a) a communication between the user and the intermediary and (b) a location of the mobile communication device.

In another aspect, the invention relates to a personal safety system including: a storage device; a computing device in communication with the storage device; and a subscriber personal safety application located on a mobile communication device located remote from the storage device and the computing device, wherein the personal safety application is in communication with the computing device, and wherein data regarding the mobile communication device and a user of the mobile communication device is sent from the subscriber personal safety application to the computing device.

In another aspect, the invention relates to a mobile communication device including a software program having computer-readable program portions, the program portions including: instructions for sending an alarm signal to an intermediary located remote from a user of the mobile communication device; instructions for automatically permitting activation of at least one of an audio communication link and a video communication link between the mobile communication device and the intermediary, based on a request from the intermediary; and instructions for dynamically updating a location of the mobile communication device.

In another aspect, the invention relates to an article of manufacture having computer-readable program portions embedded thereon for responding to an emergency request notification from a user utilizing a mobile communication device, the program portions including: instructions for receiving, by the article, an alarm signal from the mobile communication device; instructions for activating automatically at least one of an audio communication link and a video communication link between the mobile communication device and the intermediary; instructions for presenting to the intermediary a static personal information regarding the user; instructions for presenting to the intermediary a dynamic location information of the mobile communication device; and instructions for contacting a third party based on at least one of (a) a communication between the user and the intermediary and (b) a location of the mobile communication device.

### BRIEF DESCRIPTION OF THE DRAWINGS

There are shown in the drawings, embodiments which are presently preferred, it being understood, however, that the technology is not limited to the precise arrangements and instrumentalities shown.

FIG. 1 is a schematic diagram of a personal safety system and a method of operation of a personal safety system.

FIGS. 2A-2F are graphic user interfaces for a personal safety system application for use with a mobile communication device.

FIG. 3 is graphic user interface for a monitoring system.

FIGS. 4A-4C depict a method of operation of a personal safety system.

FIG. 5 is a schematic diagram of a personal safety system.

### DETAILED DESCRIPTION OF THE INVENTION

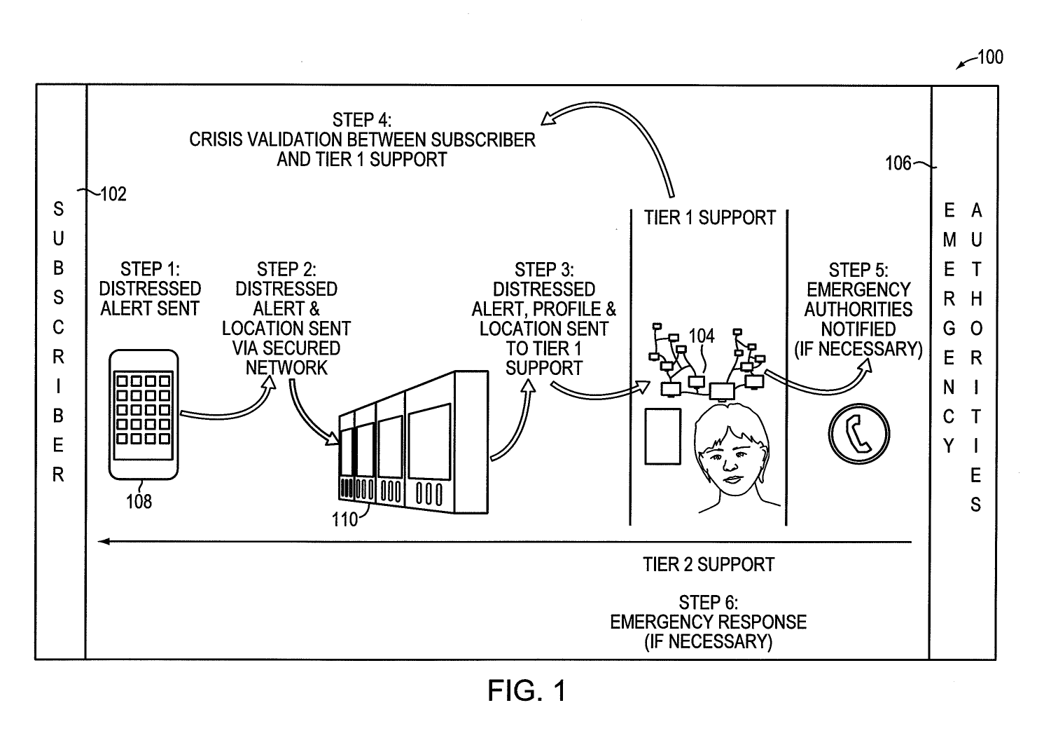

FIG. 1 depicts a personal safety system 100. Use of the system 100 includes various communications between a service user or subscriber 102 and a service provider 104, who may act as an intermediary between the subscriber 102 and emergency authorities 106. Emergency authorities 106 may include federal, state, or local police, fire departments, emergency medical services or ambulances, university or college security services, and private corporation security services (for example, on a public or private business or municipal campus).

In general, the subscriber 102 initiates a distress or alarm signal (Step 1) with a mobile communication device 108, or any device capable of being tracked by GPS or other system (such as a pendant, key chain fob, etc.). The distress signal and a location of the mobile communication device 108 are sent (Step 2) via a secured network 110 and stored thereon. The network 110 is maintained by the service provider 104, or a contractor working for the service provider 104. Software on the network 110 associates the distress signal to the specific subscriber 102, delivers to the service provider 104 information related to that subscriber 102, and collects data on the mobile communication device 108 location, leveraging various technologies, including Global Positioning Systems (“GPS”), Wi-Fi network triangulation, individual Wi-Fi IP or MAC address, cell tower triangulation, or an individual cell tower. While the alert signal is active, mobile communication device 108 location information is updated to track the location of the mobile communication device 108. The network 110 may upload and store automatically live audio and/or video of the incident from the mobile communication device 108.

The service provider 104 (through its employees or contractors) acts as the initial contact (or as so-called “Tier 1 Support”) for the subscriber 102. The service provider 104 reviews audio, video, or text messages sent from the subscriber 102 or otherwise communicates with the subscriber 102 to validate the crisis (Step 4). Validation of the crisis may confirm that there is, in fact, a crisis that requires the assistance of emergency authorities 106, or may confirm that the crisis is no longer present. If the crisis is valid, the service provider 104 contacts emergency authorities 106 (Step 5). The emergency authorities 106 act as so-called “Tier 2 Support” to further assist the subscriber 102 via an emergency response (Step 6). Further details regarding the interaction between the various entities, as well as further description of the functionality of the personal safety system 100, are described below.

The personal safety system may be a hosted, software as a service (SAAS) platform that integrates certain mobile applications to facilitate the management of crisis situations. A data center operated by a service provider serves as the central point to receive, maintain and disseminate (as appropriate) information among the disparate systems and parties involved. All subscriber and incident information is securely stored on the service provider's servers using data warehousing to facilitate rapid retrieval of the information when a crisis signal is received. In general, a subscriber logs onto a subscriber website to register for the service, provide billing information, establish a user profile, select optional settings, review reports of historical account and incident information, etc. Alternatively, data may be entered, edited, and/or stored locally, on the subscriber's mobile communication device, and synched with the data on the network. This may be desirable for subscribers that contract the services of a first service provider in a particular geographic region, but find themselves in need of assistance in a second geographic region services by a second, unrelated service provider. In such a case, there may be an arrangement between the two service providers to assist each other's subscribers based on geographic location.

The subscriber website is a hosted site that provides an interface for a subscriber to establish the personal safety service. The subscriber may perform a number of actions typical of subscriber-used internet services (e.g., establishing a user name and password, providing billing information, etc.). The subscriber also establishes a subscriber or user profile that consists of information that may be helpful in a crisis situation. This information may include a detailed description of the subscriber (e.g., height, weight, hair, eyes, sex, race, etc.), current picture, telephone number(s), email address(s), home address, driver's license number and state, affiliation (e.g., college, corporation, etc.), position (e.g., student, faculty, employee), alternative emergency contacts (e.g., name, relationship, email, and cell phone for text messaging), security password and PIN, known safety issues, health data (e.g., medical conditions, blood type, required medications, allergies) and automobile information such as make, model, year, color, and license plate number (collectively, this information is known as, “Profile Information”). The Profile Information can also be established or updated through a subscriber application (“subscriber app”) on their mobile communication device. The subscriber may be provided a number of options that affect the manner in which the personal safety system operates. Those settings may be established through the subscriber website or the subscriber app, and may include: alarm trigger, alarm mode, call center communication preference, alert contacts, etc.

The subscriber may select from a number of ways to trigger the alerting functionality of the subscriber app from their mobile communication device, including: 1) pressing a panic button presented in the interface of a touch screen device on a mobile communication device, 2) pressing a track button on a mobile communication device that highlights the panic button, 3) pressing and holding a designated speed dial button, 4) using a voice-activated command created by the subscriber (such as “HELP!”) that is recognized by the subscriber app, and/or 5) violently shaking the mobile communication device thereby triggering the alerting functionality of the subscriber app. Other options for triggering of the alarm are contemplated. Each method of triggering an alert may be dependent on the capabilities of the mobile communication device and several trigger options may be available on a single mobile communication device. The subscriber is provided the option to enable or disable each trigger option that is available.

The subscriber may also select the manner in which the personal safety system responds once an alarm is triggered: 1) an “audible alarm” setting makes a loud noise to deter an attacker, or 2) a “stealth mode” setting remains silent and the screen goes dark. In either case, the personal safety system sends a distress signal to the secured network that in turn will disseminate the alarm to an appropriate service provider or intermediary support center. The subscriber may select an initial mode of communication between the mobile communication device and the Service Provider or emergency authorities: 1) two-way communication opens up a live audio link so that the subscriber and call center representative can communicate in real time via voice; 2) one-way communication streams audio and/or video to the service provider, so that the crisis can be verified but an attacker is not aware of the alarm; or 3) text or “instant messaging” communication allows the personal safety service subscriber to communicate directly with the Service Provider or emergency authorities via text communication. If an alert is initiated with one-way communication selected, the subscriber may be presented an option to switch to two-way communication, during the incident, if desired. In most cases, communication is first established with the service provider, via one-way communication, but the subscriber may change this preference via the subscriber website or app.

The subscriber may select whether non-service provider emergency contacts (e.g., spouse, parent, friend) are notified by email or text message upon the activation of a crisis alert. The subscriber may choose to send these contacts a default generic message or create a customized message. The message may be sent with the subscriber's location at the time of the alert. Additionally, the subscriber may choose to have the emergency contact notified by the service provider via phone.

Once the subscriber has acquired the service, the subscriber may download the subscriber app to their mobile communication device. The location of the download depends on the type of mobile communication device and the service carrier. For example, the subscriber app may be downloaded from iTunes if the subscriber owns an iPhone, or from the subscriber website. The mobile communication device serves as the communication and tracking device between the subscriber and the various entities that play a role in the resolution of the incident, including the service provider, subscribing campus or other security departments, and/or emergency authorities. The subscriber app allows a subscriber to: 1) register for the personal safety service, 2) create and update the user profile, 3) change option settings, 4) activate and deactivate the alerting system, 5) trigger an alert, 6) initiate and conduct two-way communication with the specific monitoring operator handling the incident through various modes of communication, including cellular phone call, voice over internet protocol (VOIP), two-way radio signal, text message, instant messenger, or other means of voice or data communication.

While the subscriber app is compatible with multiple mobile communication devices, the service description below and the figures detail how the subscriber system may operate on an iPhone smartphone, manufactured by Apple, Inc. The system operates similarly on other mobile communication devices with the exception of necessary modifications due to differing hardware specifications and technologies offered by each device manufacturer. Other types of devices contemplated for use include smartphones, such as the BlackBerry smartphone, manufactured by Research In Motion, Ltd., smartphones manufactured by HTC Corp. or other manufacturers, or those that run operating systems such as Android, Palm, Microsoft 7, Microsoft Mobile, or other operating systems that provide the desired capability and system functionality. Additionally, full-feature cell phones that include hardware, software, and/or firmware that can be located using various location-based services may be utilized. Other compatible mobile devices (e.g., pendants, bracelets, watches, etc.) that are designed to be tracked and/or convey information using various supported technologies may be utilized.

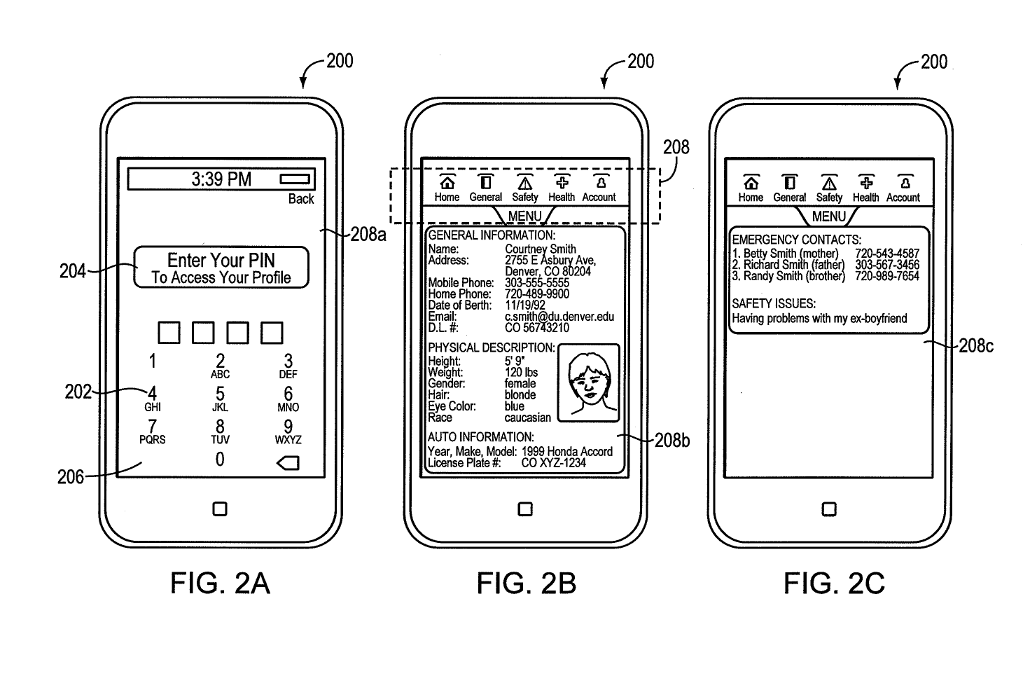

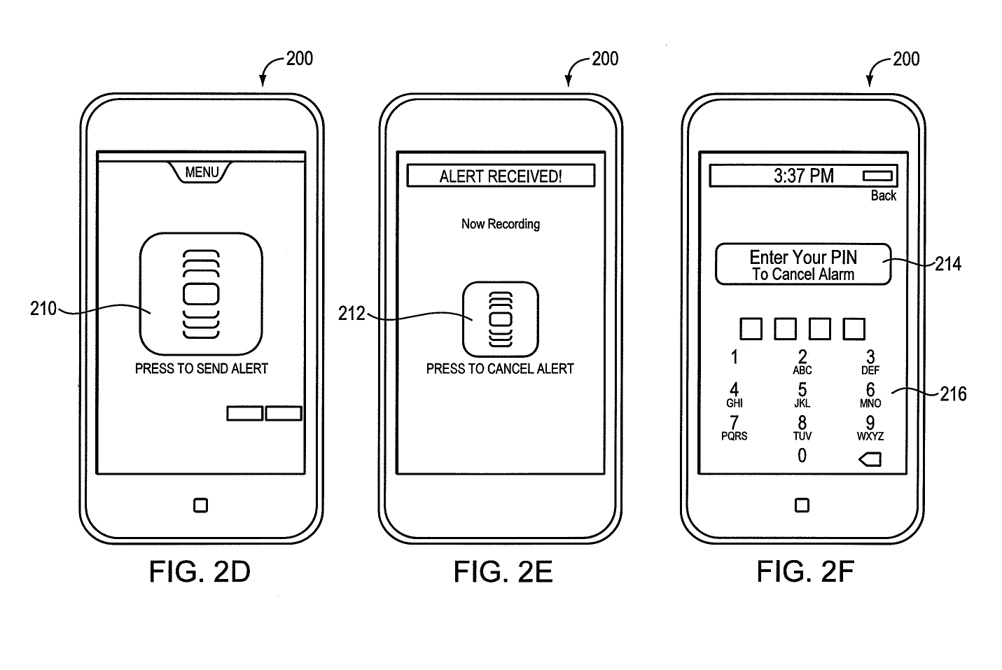

FIG. 2A depicts a mobile communication device 200 running the subscriber app. A screen 202 includes a prompt window 204 and keypad 206 in the graphic user interface (GUI) 208a. In order to access any menu item that contains personal information, the subscriber may enter a PIN established by the subscriber. After entering the correct PIN, the user is able to view and edit Profile Information, billing information, and optional settings. Access to service or safety educational information and training videos may not require the entry of a PIN. FIG. 2B depicts a sample GUI 208b depicting a “General Information” screen that displays personal information regarding the user. Other screens may be accessed via buttons or tabs located in screen selection field 208 located on the GUI 208b. FIG. 2C depicts a sample GUI 208c depicting a “Safety Information” screen. Desirable layouts of these and other screens will be apparent to a person of ordinary skill in the art.

FIG. 2D depicts the mobile communication device 200 displaying an alert button 210. By launching the subscriber app, the subscriber has access to the alert button (which can be initiated based on the trigger options available for the specific phone and as selected by the subscriber). Alternatively, the subscriber may select the option of arming the personal safety system by selecting ARM from the main subscriber app menu and entering a four-digit PIN.

FIG. 2E depicts a mobile communication device 200 in alert mode, including a cancel button 212 that allows the subscriber to cancel an alert once it has been made. Once the crisis alert is resolved, the subscriber disarms the subscriber app. If selected as an option by the subscriber, the mobile communication device 200 appears to be in sleep mode while the crisis is in process and therefore the screen will be black. By touching the screen, a deactivation screen appears prompting the user to select DISARM or CANCEL. After pressing the cancel button 212, a disarm screen appears, as depicted in FIG. 2F, and the subscriber is prompted from a prompt screen 214 to enter a PIN. Once the PIN is entered correctly on the keypad 216, the subscriber app returns to the main options page.

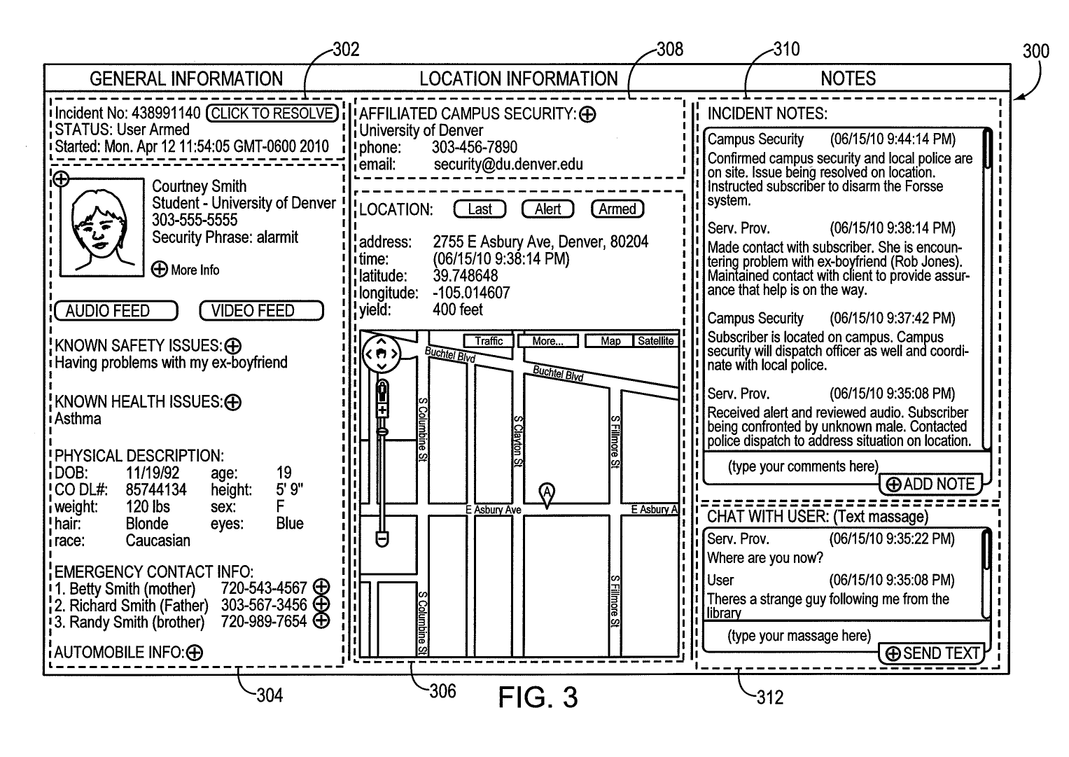

FIG. 3 depicts a graphic user interface utilized in conjunction with a monitoring interface 300 for use with a personal safety system. The personal safety system directs distress signals to one or more service providers based on the subscriber's location and affiliation (e.g., a personal safety service provider call center). Additionally, the personal safety system may also direct a distress signal to subscribing campus security services or other emergency first responders. The service provider interfaces with the personal safety system primarily through a monitoring interface 300 that provides information concerning the subscriber and the incident. The personal safety system also automates certain aspects of the crisis resolution process. A number of fields are displayed in the monitoring interface 300. These fields may include a basic incident information field that displays a queue of alerts applicable for the service provider, including basic information of each incident. For each alarm, there is certain information provided such as the incident number, start time, and a status that reflects whether the subscriber has cancelled the alarm by entering the correct PIN. A profile information field 304 displays Profile Information from the subscriber's profile who initiated an alert. Location information regarding the mobile communication device used by the user is displaced in a location field 306. The personal safety system may convert and display the following information concerning the subscriber's location: longitude and latitude, accuracy of the location reading, a representation of the location on a map, the closest street address, or other information.

Based on the location information displayed in the location field 308, the monitoring interface may also determine and present contact information for the closest appropriate emergency authorities (police, fire, medical response teams, or other designated response personnel) having emergency response responsibility in the subscriber's location. An incident notes field 310 allows the service provider or emergency authorities to enter notes about the incident. A chat field 312 allows the service provider to communicate via text message with the user. Additionally, the monitoring interface 300 allows the service provider and subscriber to initiate or receive two-way communication via various technologies, including cellular phone call, voice over internet protocol (VOIP), two-way radio signal, text message, instant messenger, or other means of voice or data communication. The monitoring interface logs the date, time and description of all activity within the system with reporting capabilities, as they occur, as described in more detail below.

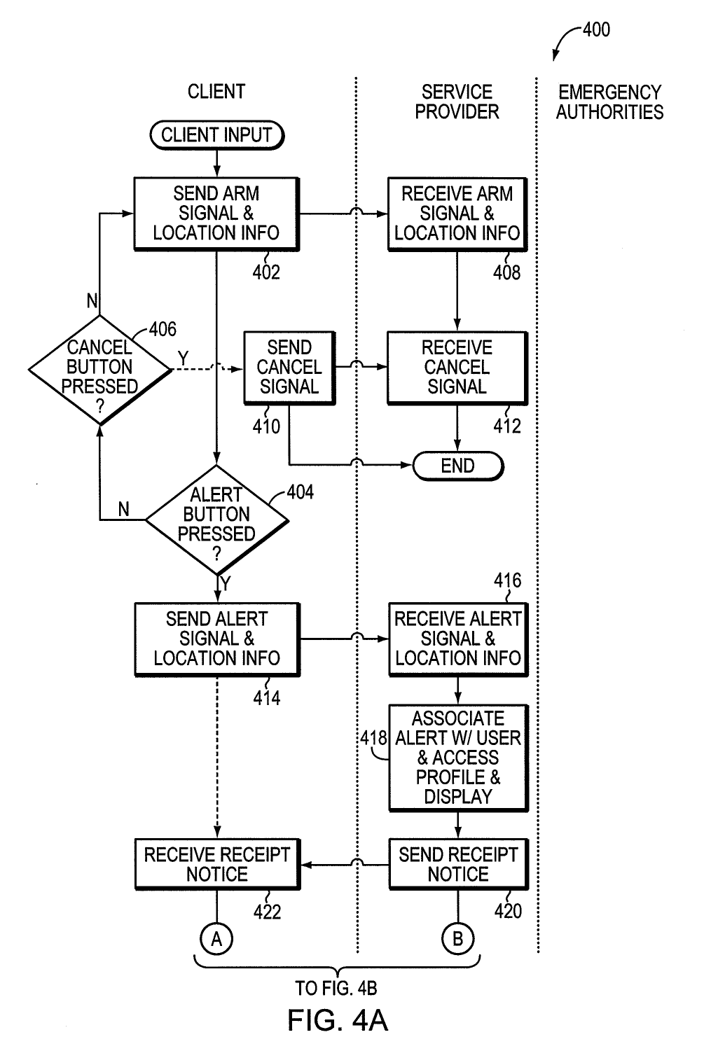

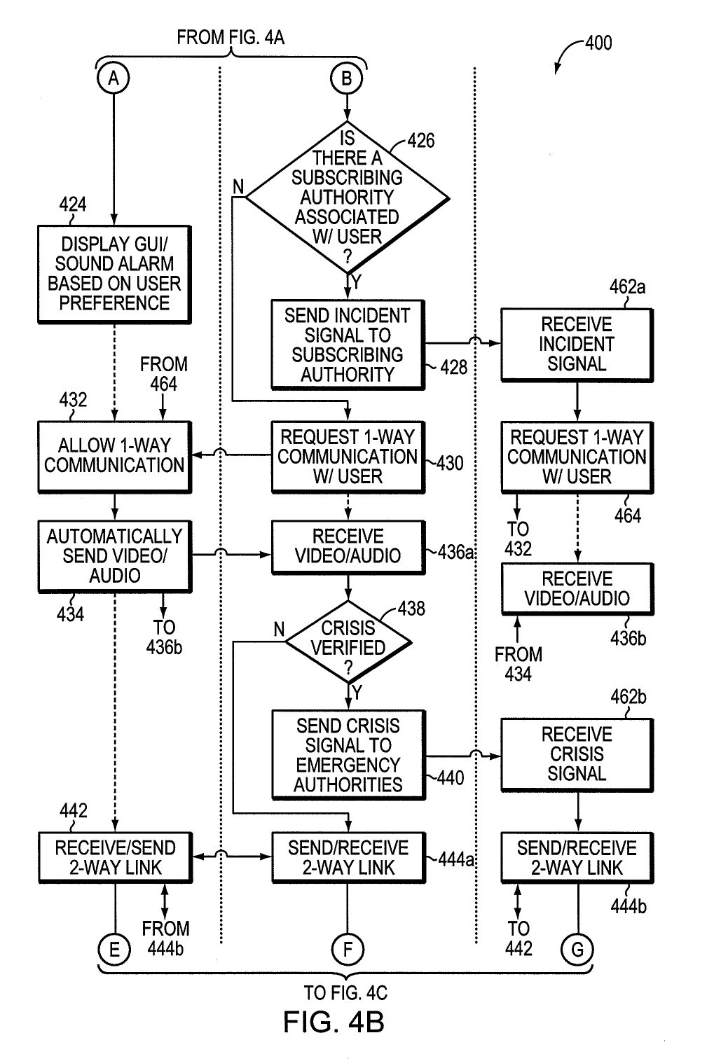

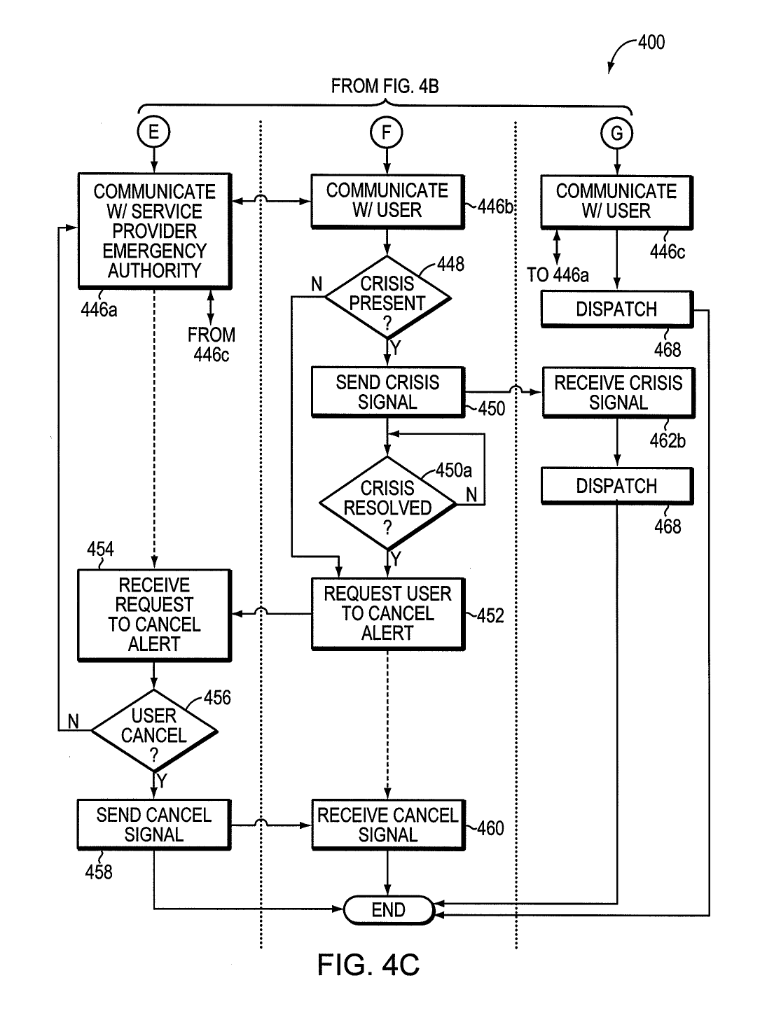

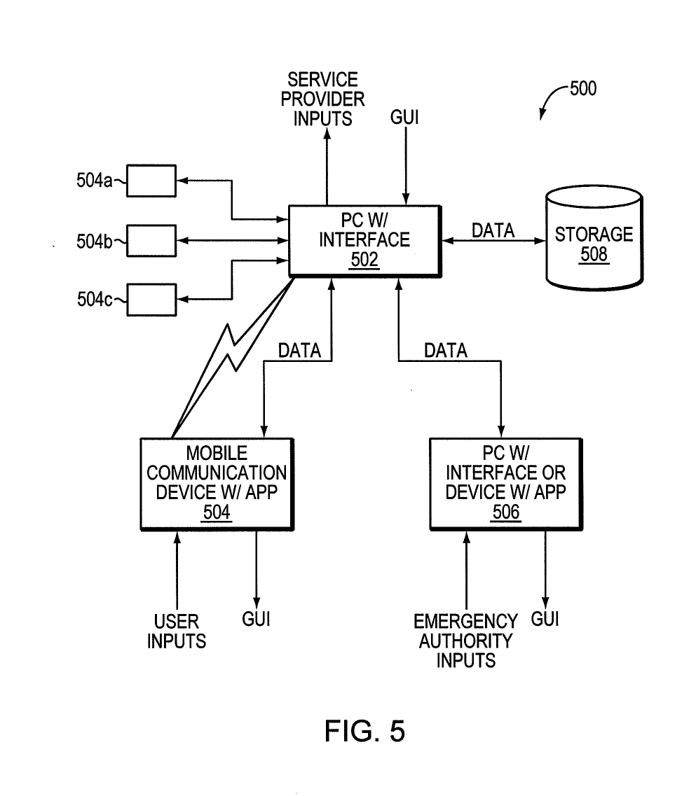

FIG. 4 depicts a method 400 of using a personal safety system. When the user or subscriber launches or arms the app, it takes a current location reading using the various technologies described herein and sends both the ARM signal and mobile communication device location to the service provider (Step 402). Regardless of the mode used to arm the personal safety system, the subscriber app may remain running and override the “sleep mode” to ensure that the alert button remains active and ready for use. The subscriber app also may override (to the extent possible) any other applications or functions that would interfere with the service.

The subscriber app remains in the ARM mode, waiting for the alert button to be pressed (Step 404). If the subscriber app is not disabled (Step 406), the subscriber app continues to update the location information of the mobile communication device. While the subscriber app is in ARM mode, location information is sent to the service provider network system using cellular, Wi-Fi, VOIP, or other transmission. The subscriber app calculates the need to send updated location information based on how fast the subscriber is moving and how accurate the data is for determining the location. For example, if the subscriber is in a car and the location is tracked by satellite, the location information may be updated in short intervals because the accuracy is strong and the change in location is significant. If the subscriber is not moving or the accuracy of information is poor, then location information may not be updated, thereby preserving battery life. The service provider network system records the time and date of activation along with available location information (latitude and longitude coordinates, accuracy, and elevation), as that information is sent to the service provider (Step 408). If the subscriber wants to disarm the subscriber app and the crisis alert was never triggered, the user selects the DISARM or CANCEL button in the subscriber app and enters the correct PIN (Step 410). If the incorrect PIN is entered three times in this mode, the subscriber app treats the situation as a crisis alert. Alternatively, another way to “disarm” the subscriber app is to close out of the application by selecting the main menu button on the mobile communication device. The service provider receives the cancel signal and terminates operation (Step 412).

The subscriber activates the distress, crisis, or alarm alert by performing one of the triggers selected in the option menu: 1) simply tapping the button presented in the subscriber app or the trackball that highlights the alarm button, 2) saying a subscriber-defined audible command (e.g., “Help!”), 3) violently shaking the mobile communication device, etc. The subscriber can select to have more than one trigger active so that there are options available during a crisis. The personal safety system records the time of the alarm activation and the location, and sends this information to the service provider (Step 414).

Once a crisis alert is received by the service provider (Step 416), the personal safety system instantaneously sends a notification to the appropriate service provider center(s) and displays the subscriber's emergency profile via the monitoring interface (Step 418). The service provider network system also associates that information with the subscriber's account/profile, and stores the information for reporting purposes. The monitoring interface includes all Profile Information and incident-specific information such as GPS mapping of the subscriber's location, links to audio and video recordings, the nearest police dispatch, contact information for any affiliated subscribing entity, as well as the ability to establish one-way communication, two-way communication, and/or text/instant messaging communication with the subscriber. If the subscriber has elected to have additional contacts be notified of the alert, the personal safety system sends a generic or pre-defined message to multiple emergency contacts via email or text message along with the subscriber's location at the time of the alert.

Once the alarm is activated, the service provider sends a receipt signal to the subscriber's mobile communication device (Step 420). Upon receipt of the receipt signal, the mobile communication device may respond with one or more vibrations to confirm for the subscriber that the crisis alert has been triggered (Step 422). Other audible, visual, and/or tactile signals indicating receipt by the mobile communication device may be utilized. Depending on the option settings selected by the subscriber, the subscriber app may: 1) fade to black after a predetermined time period so that it appears to be dormant and does not attract the attention of the assailant, or 2) sounds an alarm in loud, short intervals in an attempt to deter the assailant (Step 424). As described above, the subscriber app continues to collect location readings and transmit the data to the service provider system, and performs this function until the alert is cancelled. Each reading is date and time stamped and stored along with the subscriber's incident information.

The subscriber may select to be affiliated with a subscribing authority (e.g., campus police, etc.) or alternatively, a subscribing authority is automatically affiliated with a defined subscriber group (e.g., students). The affiliation is stored along with and as part of the Profile Information (Step 426). If there is an affiliation, an incident signal is sent to the subscribing authority (Step 428). Actions on the part of the subscribing authority are described below. Upon receiving the crisis alert, the service provider network requests an audio or video connection between the mobile communication device and the service provider (Step 430), which is automatically granted by the subscriber app (Step 432). In an alternative embodiment, the subscriber app may automatically allow one-way communication, without receiving a request from the service provider. Certain embodiments also allow the service provider to enable one-way communication without requiring permission from the subscriber app. Regardless of how one-way communication is established, all communications are recorded on a storage device, date and time stamped, and associated with the subscriber profile to maintain a record of the incident.

Thereafter, the subscriber app begins to record and stream audio and/or video to the service provider system database allowing the service provider to hear and/or see what is transpiring at the subscriber's location (Step 434). The audio/video is recorded and sent to the network system so that it can be accessed through the monitoring interface upon receipt (Step 436) by authorized subscribing authorities. The service provider is often able to verify the crisis by listening to the audio or viewing the video (Step 438). The service provider initiates the emergency response process by verifying the crisis by any or a combination of the following actions: 1) listening to or viewing audio and/or video of the incident that is recorded and transmitted from the subscriber's mobile communication device; 2) establishing two-way voice communication between the subscriber's mobile communication device and the monitoring interface; 3) establishing two-way text communication between the subscriber's mobile communication device and the monitoring interface; and/or 4) calling the subscriber's mobile telephone number provided in the emergency profile.

If the crisis is verified based on the first one-way communication, notification is sent to emergency authorities (Step 440). The service provider contacts the appropriate emergency authorities based on the subscriber's current location and/or affiliation with subscribing emergency authorities. The personal safety system identifies the nearest municipal emergency response center to facilitate the expeditious notification to emergency authorities. Additionally, the user, service provider, or emergency authorities may request or otherwise establish two-way communication or text/instant messaging communication with the service provider by selecting that option after the crisis alert is triggered (Step 442). When the crisis alert is activated, two-way communication need not be automatically established because it could draw the unwanted attention of the assailant. The subscriber is provided the option to turn on two-way communication. If the subscriber selects that option, a real-time audio link is connected between the mobile communication device and the service provider interface allowing real-time communication between the subscriber and service provider (Step 444). Depending on the capabilities of the mobile communication device, the two-way communication may be established through a cellular phone call or data transmission of audio using technologies such as VOIP (Step 446a). The communication may be between the subscriber and the service provider (Step 446b) and/or the emergency authorities (Step 446c).

When the alert signal is activated, the subscriber has the ability to initiate text/instant messaging communication with the service provider. If the subscriber selects this option, a real-time text/instant messaging chat session is established between the subscriber app and/or the audible communication device. The subscriber is able to read and respond to messages generated by the service provider through the subscriber app, while the service provider is able to view and respond to text/instant messages through the monitoring interface. This text/instant message communication is also contemplated as part of Step 446. Additionally, if the service provider is able to verify a crisis based on the two-way communication (Step 448), a crisis signal may then be sent to the emergency authorities (Step 450). The service provider is able to forward profile information to emergency authorities either through fax, email, web service, API, or other data transmission. Alternatively, emergency authorities are granted temporary access to the monitoring interface for a specific incident by forwarding a internet link that is credentialed for automatic access. Once the incident is closed within the network system, the link may no longer work. Additionally, the service provider is able to provide live updates of the subscriber's location to emergency authorities. The service provider enters notes about an incident into the system through the monitoring interface.

If the crisis is resolved, either due to termination of the crisis (e.g., a false alarm) or because the emergency authorities have provided the necessary assistance (Step 450a), the service provider may request that the user cancel the alert (Step 452). The service provider system records the time and date of the deactivation. Upon receipt of the cancel request, the user may disarm the subscriber app (Step 454). If the wrong PIN is entered, the subscriber app displays a screen indicating the problem and requests the subscriber to re-enter the PIN. If the incorrect PIN is entered a predetermined number of times, the alarm will not be cancelled (Step 456), and a message is sent to the service provider system and displayed in the monitoring interface. This failure to properly cancel will continue the incident, allowing the service provider to continue to render assistance. Once the proper cancellation procedure is followed and a cancel signal is sent (Step 458), the monitoring interface displays that the user disarmed the alert and the service provider may close out or “resolve” the alert once all aspects of the crisis have been addressed (Step 460).

Returning to Step 426, it is contemplated that in certain embodiments, subscribing authorities may be connected to the incident prior to the verification of a crisis. The monitoring interface is used by the service provider to receive and manage crisis alerts. While it may be desirable that the service provider provides oversight on all personal safety system alerts, a third-party may subscribe to receive alerts that are: 1) generated within a specified area and/or 2) generated by an end user that has affiliated with the organization (e.g., student or faculty member of a college) regardless of where the alert is triggered. These entities may provide support to the subscriber, such as campus security departments of colleges, corporation, hospitals, as well as Public Service Answering Points (911 centers or other emergency dispatch).

These organizations are provided access to the personal safety system with a queue of any alerts associated with their specific organization. The personal safety system is able to filter alerts by subscriber and alert location and send alerts that are relevant to the subscribing account and campus (Step 428). The receiving subscribing entity is able to click on any alert in the queue to have full access to the monitoring interface for the specific alert (Step 462a). Interaction between the emergency authorities and subscriber (whether because the emergency authority is a subscribing authority, or because the emergency authority was sent a crisis signal), may be similar to the interactions between the subscriber and the service provider. The emergency authorities receive a crisis signal from the service provider (Step 462b). The emergency authority may request one-way communication (Step 464) and receive video/audio feeds (Step 436b), typically sent via the service provider. Additionally, the emergency authorities may request a two-way communication link or receive such a request from the subscriber (Step 444b), and thereafter communicate with the subscriber (Step 446c), prior to dispatching assistance (Step 468). Even during one- or two-way communication, the service provider may remain in contact, so information about the incident can be recorded and stored. If an organization subscribes to receive alerts for all individuals associated with their organization, the subscribers will affiliate with the organization during the registration process by entering (or selecting from a list) the name of the institution in an “Affiliated Entity” field on the subscriber website or app. Any time an alert is generated by an affiliated subscriber (regardless of location) the subscribing entity is notified through the personal safety system.

An organization can also subscribe to receive alerts if there is a personal safety alert generated in a specified location, such as a campus. During the registration process for the organization, a geo-fence is created by entering the geo-coordinates (latitude & longitude coordinates) into the personal safety system that accurately outline and define the campus boundary. A single campus may be associated with multiple geo-fences to cover specific areas that are oddly shaped or that are not connected with other areas of the campus. If a personal safety alert is triggered within the coordinates of the geo-fence, the subscribing entity will be notified of the alert through the personal safety system. Additionally, additional system functionality may be available on campuses or other locations that utilize video camera surveillance systems or security alarm stations. For example, if a subscriber sends an alert to the service provider, the personal safety system may locate the nearest video camera to the location of the mobile communication device and stream video from that camera to the service provider. If the video camera includes the capability, the service provider may direct the camera to change its field of view towards the location of the mobile communication device. Locations that utilize security call boxes may also be able to sound audible or visual alarms at the call box closest to the location of the mobile communication device.

The personal safety system provides enhanced location services to subscribing institutions, which allows for increased location accuracy for alerts that are activated within buildings and other structures (e.g., parking garages) that do not have direct GPS satellite coverage. Alternate or additional location services use static MAC addresses, IP addresses, and/or Wi-Fi hub names of Wi-Fi networks to locate a subscriber within a building or structure. The service provider works with subscribing institutions to create a database of Wi-Fi access points (static MAC and/or IP addresses of various Wi-Fi hubs in the area). Each access point is assigned a specific location as it relates to a building or a structure. Wi-Fi enabled mobile communication devices that are capable of reading the access point addresses will transmit this information to the personal safety system, which will in turn associate that data with the description of the access point location and display the description in the monitoring interface. Additionally, the personal safety system may use Wi-Fi triangulation services to obtain more accurate location information when there are multiple Wi-Fi networks and/or access points.

Emergency authorities can subscribe to the personal safety system to allow their emergency response personnel to download an emergency authority monitoring app to a mobile communication device. The personal safety system is able to locate a subscribing emergency authority member via GPS or other location service on the team member's mobile communication device. This feature allows the personal safety system to identify emergency response personnel closest to the subscriber's location and notify them of the subscriber's situation. When there is a personal safety alert in the proximity of an emergency authority member, he/she will receive the alert through the emergency authority monitoring app and have access all crisis information available through the standard monitoring interface, including the profile, location information, incident notes, one- or two-way communication, and text messaging exchange. The emergency authority monitoring app will also allow the representative to interface with the monitoring interface by entering incident notes. Alternatively or additionally, emergency authorities access the relevant information about an incident via software or a secure internet connection via a laptop or other portable computer (e.g., as typically present in a police cruiser).

If there is no cellular coverage during an alert, the subscriber app will continue to store locally on the mobile communication device the information described. Once cellular connectivity is established, the subscriber app will transmit the information to the personal safety system. As an emergency response system, maintaining the battery life of the mobile communication device is critical to continue to transmit crisis information to the monitoring interface. As such, the subscriber app polls the mobile communication device to determine an estimated battery life. Based on the battery life of the mobile communication device, the subscriber app will manage the resources accordingly based on the importance of specific data being transmitted and the amount of associated battery consumption. For example, video may be turned off because there is not enough battery life to support that activity and it is more important to track the user's location for a longer period of time. Additionally, the service provider may override predetermined logic of resource management and control the functions of the subscriber app. For example, the service provider may determine video is extremely important for a period of time and restart video because there is no change in location.

In certain embodiments, the service provider is able to remotely control certain features on the phone, such as turning on and off audio and video recording or using the camera features to take pictures. This provides the ability to obtain information necessary to respond to the situation, but only to the extent necessary in order to preserve battery life. If the alert is a false alarm, the service provider contacts the subscriber to assist the subscriber in disarming the system.

The personal safety system operates as an evidentiary record, maintaining detailed records of all information related to a crisis incident, including a recording of all communications, audio and video recordings, GPS location information, and notes entered by the service provider or emergency authorities. All information is stored in association with the subscriber's profile on the personal safety system. The personal safety system provides a very comprehensive set of information to allow authorities to reconstruct an incident. The personal safety system is able to present the various pieces of information collected by the system along a time continuum: GPS location, audio, video, still image, service provider notes, and telephone communication. Each item is date, time, and geo-code stamped in the system. This allows authorities to gain a much better understanding of what occurred during an incident, as well as recreate events leading up to, during, and through the resolution of crisis situation.

FIG. 5 depicts components of a personal safety system 500. The system 500 includes stand-alone PC or other computing device 502 utilized by a service provider or intermediary, a mobile communication device including a subscriber personal safety application 504, a PC with a emergency authority interface or a mobile communication device with a emergency authority app 506, and a storage device 508 located so as to be accessed by the service provider. The mobile communication device 504 may be one of several mobile communication devices 504a, 504b, 504c used by a number of subscribers.

The service provider provides inputs to the service provider PC 502 and receives feedback and information via the GUI. Similarly, the user or subscriber, and the emergency authorities, each provide inputs to their respective devices 504, 506, and receive feedback and information via their respective GUIs. Communication between the mobile communication device 504 and the PC 502 is over a typical cellular telephone network, but may also utilize a POTS connection, or other communication network. Data sent between the mobile communication device 504 and the service provider 502 may include all the information described above, including mobile communication device location information, subscriber information, or other identifying information (e.g., a mobile communication device identifier) that would enable the service provider PC 502 to access related subscriber data in the storage device 508. Additionally, all video, audio, and text communication may be included in the sent data.

The storage device 508 is a repository for all the subscriber information, incident data, etc., utilized by the personal safety system 500. Certain data is delivered from the storage device 508 to the service provider PC 502 for use in resolving crisis incidents. The type of information delivered is described above. Similarly, all, or a subset, of this data may be sent to the emergency authority device 506, as needed to inform the authorities, or to assist in resolving a crisis. This data includes information described above, and may include subscriber Profile Information, mobile communication device 504 location, video/audio/text communications (both one- and two-way), etc. Data sent from the emergency authority device 506 to the service provider PC 502 may include incident notes or other information. All data sent between components of the personal safety system 500, as well as time and date recordation of data transmissions and actions taken by any of the entities involved, may be stored in the storage device 508.

The present technology can be realized in hardware, software, or a combination of hardware and software. The present technology can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present technology also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

In the embodiments described above, the software may be configured to run on any computer or workstation such as a PC or PC-compatible machine, an Apple Macintosh, a Sun workstation, etc. In general, any device can be used as long as it is able to perform all of the functions and capabilities described herein. The particular type of computer or workstation is not central to the technology, nor is the configuration, location, or design of a database, which may be flat-file, relational, or object-oriented, and may include one or more physical and/or logical components.

The computers may include a network interface continuously connected to the network, and thus support numerous geographically dispersed users and applications. In a typical implementation, the network interface and the other internal components of the computers intercommunicate over a main bi-directional bus. The main sequence of instructions effectuating the functions of the technology and facilitating interaction among clients, computers and a network, can reside on a mass-storage device (such as a hard disk or optical storage unit) as well as in a main system memory during operation. Execution of these instructions and effectuation of the functions of the technology is accomplished by a central-processing unit (“CPU”).

A group of functional modules that control the operation of the CPU and effectuate the operations of the technology as described above can be located in system memory (on the same or a separate device, as desired). An operating system directs the execution of low-level, basic system functions such as memory allocation, file management, and operation of mass storage devices. At a higher level, a control block, implemented as a series of stored instructions, responds to client-originated access requests by retrieving the user-specific profile and applying the one or more rules as described above.

Communication may take place via any media such as standard telephone lines, LAN or WAN links (e.g., T1, T3, 56 kb, X.25), broadband connections (ISDN, Frame Relay, ATM), wireless links, and so on. Preferably, the network can carry TCP/IP protocol communications, and HTTP/HTTPS requests made by the client and the connection between the client and the server can be communicated over such TCP/IP networks. The type of network is not a limitation, however, and any suitable network may be used. Typical examples of networks that can serve as the communications network include a wireless or wired Ethernet-based intranet, a local or wide-area network (LAN or WAN), and/or the global communications network known as the Internet, which may accommodate many different communications media and protocols.

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. A method of notifying an intermediary located remote from a user of an emergency service requested by the user associated with a mobile communication device, the method comprising:
receiving, at the intermediary, an alarm signal generated by a user interaction with a safety application on the mobile communication device;
activating at least one of an audio communication link and a video communication link between the mobile communication device and the intermediary based on the user's interaction with the safety application;
presenting to the intermediary a static personal information regarding the user;
presenting to the intermediary a dynamic location information of the mobile communication device; and
contacting a third party based on at least one of (a) a communication between the user and the intermediary and (b) a location of the mobile communication device.

2. The method of claim 1, further comprising activating a text communication link between the mobile communication device and the intermediary.

3. The method of claim 2, further comprising:
receiving, at the intermediary, an arm signal from the mobile communication device; and
receiving, at the intermediary, dynamic location information of the mobile communication device.

4. The method of claim 3, further comprising:
receiving, at the intermediary, a cancel signal from the mobile communication device,
wherein the cancel signal deactivates at least one of the audio communication link, the video communication link, and the text communication link between the mobile communication device and the intermediary, and
wherein the cancel signal terminates presentation of dynamic location information of the mobile communication device.

5. The method of claim 1, further comprising storing information received from at least one of the audio communication link, the video communication link, the text communication link, and the dynamic location information.

6. The method of claim 1, wherein the static personal information comprises at least one of a physical description, a vehicle description, a medical information description, a safety description, an emergency contact description, and an associated third party description.

7. The method of claim 1, wherein the static personal information is stored at the intermediary.

8. The method of claim 1, further comprising storing comments prepared by the intermediary.

9. The method of claim 1, wherein the activating step comprises calling a number associated with the mobile communication device.

10. A personal safety system comprising:
a storage device;
a computing device in communication with the storage device; and
a subscriber personal safety application located on a mobile communication device located remote from the storage device and the computing device, wherein the personal safety application is in communication with the computing device, and wherein data regarding the mobile communication device and a user of the mobile communication device is sent from the subscriber personal safety application to the computing device.

11. The personal storage system of claim 10, wherein the data comprises at least one of a mobile communication device location and a subscriber identifier.

12. The personal safety system of claim 10, wherein the storage device sends information to the computing device based at least in part on the data, wherein the information comprises at least one of a physical description, a vehicle description, a medical information description, a safety description, an emergency contact description, and an associated third party description.

13. The personal safety system of claim 10, wherein the data comprises at least one of a video communication, an audio communication, and a text communication.

14. A mobile communication device comprising a software program having computer-readable program portions, the program portions comprising:
instructions for sending an alarm signal to an intermediary located remote from a user of the mobile communication device;
instructions for automatically permitting activation of at least one of an audio communication link and a video communication link between the mobile communication device and the intermediary, based on a request from the intermediary; and
instructions for dynamically updating a location of the mobile communication device.

15. The mobile communication device comprising a software program having computer-readable program portions of claim 14, the program portions further comprising instructions for permitting activation of a text communication link between the mobile communication device and the intermediary, based on a request from the intermediary.

16. An article of manufacture having computer-readable program portions embedded thereon for responding to an emergency request notification from a user utilizing a mobile communication device, the program portions comprising:
instructions for receiving, by the article, an alarm signal from the mobile communication device;
instructions for activating automatically at least one of an audio communication link and a video communication link between the mobile communication device and the intermediary;
instructions for presenting to the intermediary a static personal information regarding the user;
instructions for presenting to the intermediary a dynamic location information of the mobile communication device; and
instructions for contacting a third party based on at least one of (a) a communication between the user and the intermediary and (b) a location of the mobile communication device.
